(19) United States
(12) Patent Application Publication
(10) Pub. No.: US 2022/0359130 A1
(43) Pub. Date: Nov. 10, 2022

(54) Adjustable Snap-Action Limit Switch Mount

(71) Applicant: Peter C. BENJAMIN, Dayton, OH (US)

(72) Inventor: Peter C. BENJAMIN, Dayton, OH (US)

(21) Appl. No.: 17/314,246

(22) Filed: May 7, 2021

(51) Int. Cl. H01H 9/02

(52) U.S. Cl. CPC H01H 9/0207; H01H 5/00

(57) ABSTRACT

An adjustable mount for an electrical device (such as a limit switch) or an optical device that includes: (a) a base adapted to be mounted to a surface; and (b) a platform coupled to and elevated above the base; where the platform includes, a top surface for seating an electrical sensor device or an optical device thereon, a through-hole approximate a first end of the top surface for receiving a first screw extending from the electrical sensor device or optical device, and an arcuate through-slot approximate a second end of the top surface opposite the first end for receiving a second screw extending from the electrical sensor device or optical device, the arcuate through-slot having a radius of curvature centered near or on the through-hole.

### BACKGROUND

Snap-action switches are commonly used as limit switches in industrial automation, processing equipment and machinery control. Typically, an OEM or Systems House that integrates limit switches into its products does so by designing a custom means of holding and positioning such switches.

Commonly available “chassis mounted” snap-action switches can be grouped into four form factors: Miniature, Standard, Non-Typical Miniature Hobbyist and Subminiature. Representative illustrations of these form-factors are shown below in FIG. 1.

As shown in FIG. 1, all form-factors have two holes through the body of the switch. Though other means of mounting are possible, the two thru-holes are the means by which switches are commonly affixed to a mount. Besides overall size, the geometric configuration of the thru-holes is primarily what distinguishes one form-factor from another.

### SUMMARY

Embodiments of the current disclosure are intended to obviate the need for creating a new mount for every application. Specifically, embodiments of the current disclosure are designed to provide the user with an off-the-shelf solution to hold and position most of the snap-action switches sold worldwide, while also allowing a large amount of adjustability in a small footprint that is low in cost. Embodiments of the current disclosure are designed to accommodate all four form-factors. In fact, as will be shown in the detailed description, one embodiment can accommodate three of the four form-factors.

It is an aspect of the current disclosure to provide an adjustable mount for an electrical device (such as a limit switch) or an optical device that includes: (a) a base adapted to be coupled to a surface of an object (such as a circuit board, an optical board, an electro-mechanical, and electrical optical assembly and the like); and (b) a platform coupled to and elevated above the base; where the platform includes, a top surface for seating an electrical sensor device or optical device thereon, a through-hole approximate a first end of the top surface for receiving a first screw extending from the electrical sensor device or optical device, and an arcuate through-slot approximate a second end of the top surface opposite the first end for receiving a second screw extending from the electrical sensor device or optical device, the arcuate through-slot having a radius of curvature centered near or on the through-hole.

In a more detailed embodiment, the platform includes a bottom surface and the bottom surface includes an arcuate track following the path of the arcuate through-slot, the acuate track dimensioned to capture a screw-nut therein and allow the screw-nut to slide along the arc of the track. In a more detailed embodiment, the track has a rectangular cross-section for guiding a hex-nut therein while preventing the hex nut from rotation on the screw extending from the electrical sensor device.

Alternatively, or in addition, the base is a planar base and the platform lies on a plane parallel to that of the planar base. In a more detailed embodiment, the planar base includes a pair of through-slots for receiving mounting screws therethrough. In yet a further detailed embodiment, the pair of through-slots are straight and extend into opposing end faces of the planar base; and the pair of through-slots extend along the same line or respectively extend along parallel lines.

Alternatively, or in addition, the through-hole is elongated towards or away from the arcuate through-slot to provide a variable radius.

Alternatively, or in addition, the platform sits on from a vertical beam extending from the base.

Examples disclosed herein show that the electrical device can be a sensor, such as a limit switch, but it will be appreciated that the mount may be useful for other electrical devices, optical devices (e.g., lasers, light-guides, lenses and the like) or even mechanical devices.

### BRIEF DESCRIPTION OF THE DRAWINGS

FIG. 1 provides examples of prior art limit switches for which the mount of the current disclosure is designed to support;

FIG. 2A is a perspective view of a prior art limit switch;

FIG. 2B is a perspective view of the limit switch of FIG. 2A mounted on an exemplary mount of the current disclosure;

FIG. 2C is a perspective view of an exemplary mount of the current disclosure;

FIG. 3 is a perspective and transparent view of an exemplary mount of the current disclosure with hidden components/lines shown in phantom;

FIG. 4A is a top and transparent view of a limit switch mounted on an exemplary mount of the current disclosure with hidden components/lines shown in phantom;

FIG. 4B is a side view of FIG. 4A;

FIG. 4C is a bottom perspective view of FIGS. 4A and 4B;

FIG. 5 is a bottom view of an arcuate hex-nut track according to an embodiment;

FIG. 6 is a top and transparent view of an exemplary mount of the current disclosure with hidden components/lines shown in phantom;

FIG. 7A is a perspective view of an exemplary mount of the current disclosure with a variable radius design;

FIG. 7B is a perspective view of an exemplary mount of the current disclosure with a fixed radius design;

FIG. 8 is a top and transparent view of the exemplary mount of FIG. 7A (variable radius design) with hidden components/lines shown in phantom;

FIG. 9A is a top and transparent view of the exemplary mount of FIGS. 7A and 8 with a miniature limit switch mounted thereon;

FIG. 9B is a top and transparent view of the exemplary mount of FIGS. 7A and 8 with a standard limit switch mounted thereon;

FIG. 9C is a top and transparent view of the exemplary mount of FIGS. 7A and 8 with a miniature hobbyist limit switch mounted thereon;

FIG. 10A is a top view of an embodiment of the current disclosure incorporating a second mount and a right-angle adaptor to provide additional dimensions of adjustability;

FIG. 10B is a side view of FIG. 10A; and

FIG. 10C is a perspective view of FIGS. 10A and 10B.

### DETAILED DESCRIPTION

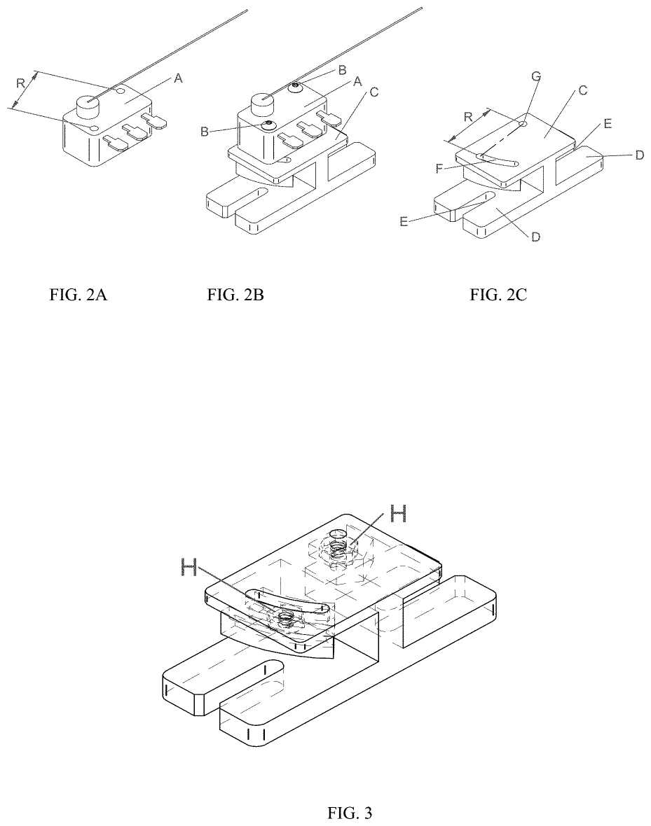

In the basic embodiment (FIGS. 2A-2C), an electrical device such as a snap-action switch (A) is attached via two machine screws (B) to a molded low-profile platform (C) that houses two (2) standard hex nuts (H, FIG. 3) into which the machine screws (B) are affixed. The top surface of the platform (C) has an arcuate thru-slot (F) whose center radius (R) is equal to the distance between centers (R) of the switch mounting holes and is positioned from a thru-hole (G) located at its radial center.

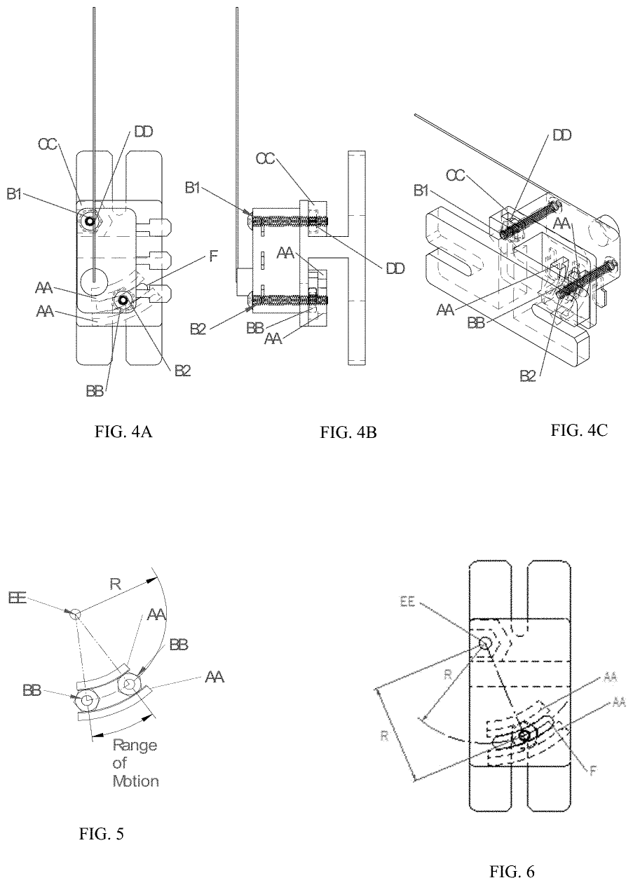

Referring to FIGS. 4A-4C, beneath the arcuate thru-slot (F) is an arcuate track (AA) into which a standard hex nut (BB) is inserted from either end of the track. The track has a bottom flange that keeps the face of the nut perpendicular to the arcuate slot. The bottom flange also has a thru-arcuate slot that allows the machine screw (B2) to protrude out beyond the flange. The width of the track is such that a standard hex nut may readily slide from one end of the track to the other, but is narrow enough to restrict the nut from freely rotating (other than the rotation created as the nut travels along the track). This is shown in FIG. 5. Beneath the thru-hole (G, FIGS. 2A-2C) is a closed-end slot (CC, FIGS. 4A-4C) into which a second standard hex nut (DD) is inserted. In conjunction with the closed-end slot that conforms to the hexagonal shape of the nut, a flange on the bottom of the slot keeps the face of the nut both perpendicular and centered on the thru-hole, while also preventing the nut's rotation. Additionally, the bottom flange has a thru-hole that allows the machine screw (B1) to protrude through the flange.

Additionally, as shown in FIGS. 2A-2C, the platform (C) is elevated over a planar base by a vertical beam. The planar base has two flanges (D) with longitudinal thru-slots (E) used for attaching the mount with screws to a fixed surface, while allowing adjustability in longitudinal positioning. It will be appreciated that the flanges (D) and longitudinal thru-slots (E) could be directed in a perpendicular direction to provide adjustability in that direction. Similarly, the platform (C) can be rotated (e.g., 90°) with respect to the base.

Referring to FIGS. 2A-2C, to adjust the angular positioning of the snap-action switch (A) relative to the platform mount (C), one merely leaves both machine screws (B) slightly loose with respect to the two hex nuts (FIGS. 4A-4C, BB and DD) and then rotates the body of the snap-action switch (A) until the desired position is reached. Then to lock the snap-action switch (A) into position, one tightens down the two machine screws (B).

The basic embodiment shown in FIGS. 2A-2C is compatible only with snap-action switches having the same distance between centers of the switch mounting holes as the distance (R). Referring to FIG. 6, it can be seen that this is true since the arcuate track (AA) and it's matching arcuate thru-slot (F) are at a fixed radius (R) from thru-hole (EE).

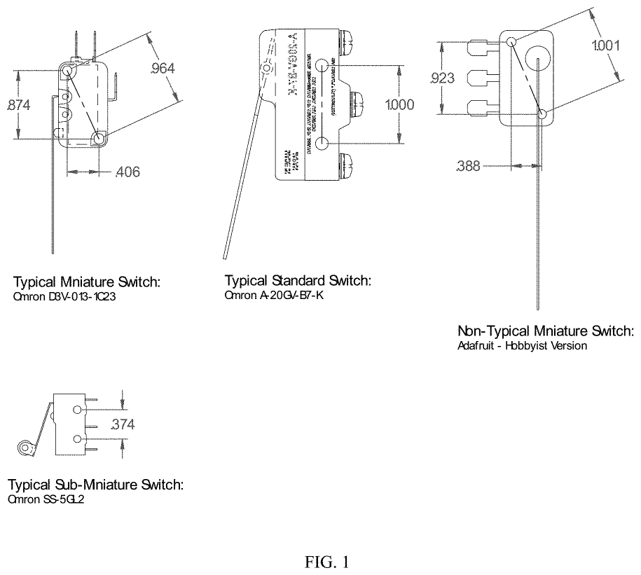

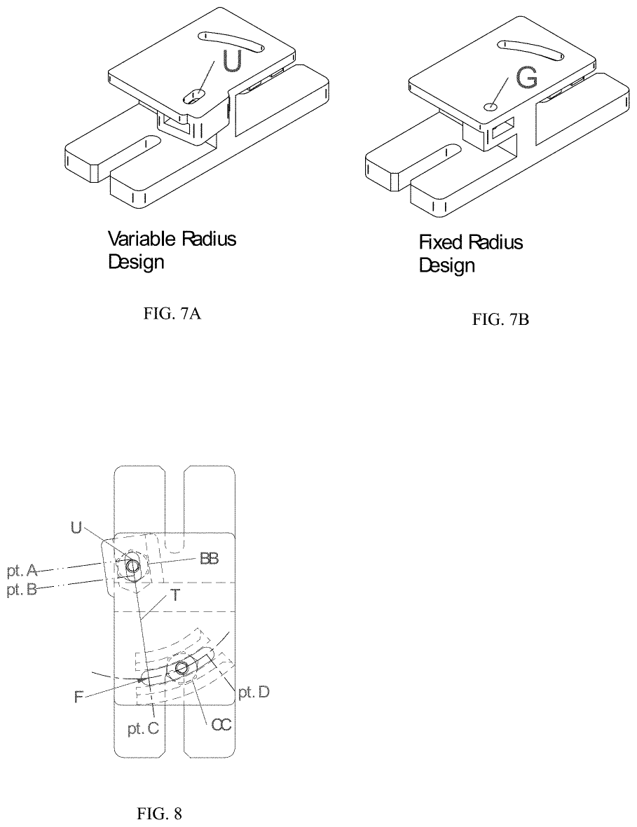

As shown in FIG. 1, the distances between centers of the switch mounting holes for the four form-factors of snap-action switches are (in inches): 0.964, 1.000, 1.001, 0.374. Therefore, three versions of the disclosure (having three different radiuses) would be required to accommodate all four form-factors. A modification to the basic embodiment is shown below in FIG. 7B, as a Variable Radius Design. The basic, Fixed Radius Design embodiment is shown side-by-side in FIG. 7A. The Variable Radius Design (FIG. 7B) replaces the thru-hole (G) in the Fixed Radius Design (FIG. 7A) with a linear or elongated thru-slot (U).

As shown in FIG. 8, the linear thru-slot (U) allows the pivot point [at the center of hex nut (BB)] to move towards or away from the arcuate thru-slot (F) along a line (T) which is collinear with the radial line which defines the beginning of the arcuate thru-slot.

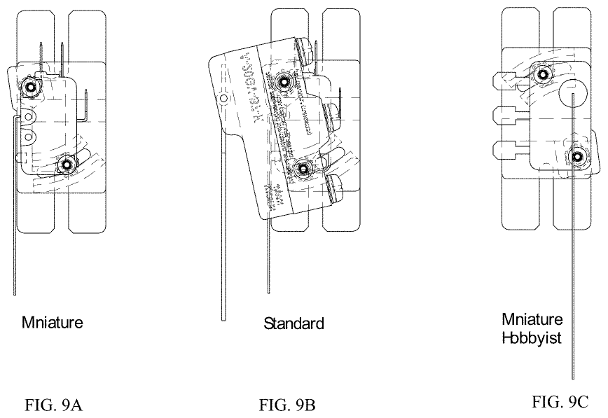

This Variable Radius Design will accommodate switches having different center-to-center distances between mounting holes when the difference between them is small. Although thru-slot (F) is of a fixed radius, a quasi-variable radius is achieved by allowing hex nut (BB) to slide from Point A (pt. A) towards Point B (pt. B). Therefore, when angularly positioning a switch counterclockwise, hex nut (CC) will slide along the path of the arcuate thru-slot (F) away from Point C (pt. C) towards Point D (pt. D) and hex nut (BB) will slide along the linear thru-slot (U) away from Point A (pt. A) towards Point B (pt. B). Thus, a single Variable Radius Design mount can accommodate all form factors except the Subminiature [because of the large difference in center-to-center mounting hole spacing (1.000 in vs 0.374 in)]. Finally, the universality of the Variable Radius Design can be seen in FIGS. 9A-9C which illustrates how one Variable Radius Design can accommodate three of the four switch form-factors.

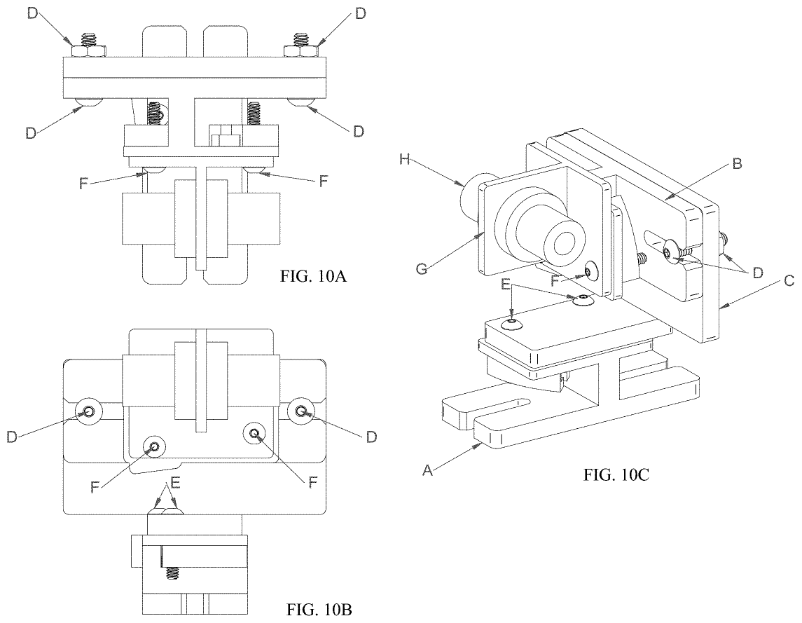

It is also envisioned that the current disclosure may be used multiply within an assembly to provide multiple axes of adjustment. One such arrangement is shown in FIGS. 10A-10C where two instances of the current disclosure are employed to provide adjustment in both azimuth (A) and elevation (B). The two instances are joined by a right-angle adapter (C) that maintains the orthogonal relationship between the azimuth mount (A) and the elevation mount (B) by affixing the elevation mount (B) to the vertical beam of right-angle adapter (C) via two machine screws and nuts (D) and attaching the horizontal beam of right-angle adapter (C) to the azimuth mount (A) via two machine screws (E). Consistent with the type of sensor employed, a sensor adapter (G) attaches a sensor (H) to the elevation mount (B).

FIGS. 10A-10C generically illustrate a round sensor (G); however, other form-factors can be accommodated by employing an appropriate sensor adapter. Positional adjustment is made in azimuth by loosening the two screws (E), rotating the right-angle adapter (C) to the desired location and then tightening screws (E) to lock the azimuthal position. Similarly, positional adjustment is made in elevation by loosening the two screws (F), rotating the sensor adapter (G) to the desired location and then tightening screws (F) to lock the elevational position.

Embodiments of the current disclosure may be formed from a rigid plastic material, or other suitable sufficiently rigid material, which is preferably (but not necessarily) an insulative material due to the mounted electronics. Embodiments may be molded, 3D printed, machined, assembled or formed from any other suitable manufacturing process. While embodiments of the current disclosure are unitary, it is within the scope of the current disclosure that embodiments may be assembled from component pieces.

Having described exemplary embodiments of the current disclosure it will be apparent to those of ordinary skill that modifications can be made to such embodiments without departing from the scope and spirit of the inventions as claimed. It will also be apparent that it is not necessary to meet any or all of the stated advantages or objects described herein because additional advantages may be apparent that are not necessarily detailed herein.

What is claimed is:

1. An adjustable mount for an electrical or optical device comprising:
a base adapted to be removably coupled to a surface; and
a platform coupled to and elevated above the base, the platform including,
a top surface for seating an electrical or optical device thereon,
a through-hole approximate a first end of the top surface for receiving a first screw extending from the electrical sensor device, and
an arcuate through-slot approximate a second end of the top surface opposite the first end for receiving a second screw extending from the electrical sensor device, the arcuate through-slot having a radius of curvature centered near or on the through-hole.

2. The adjustable mount of claim 1, wherein:
the platform includes a bottom surface; and
the bottom surface includes an arcuate track following the path of the arcuate through-slot, the acuate track dimensioned to capture a screw-nut therein and allow the screw-nut to slide along the arc of the track.

3. The adjustable mount of claim 2, wherein the track has a rectangular cross-section for guiding a hex-nut therein while preventing the hex nut from rotation on the screw extending from the electrical sensor device.

4. The adjustable mount of claim 1, wherein the base is a planar base and the platform lies on a plane parallel to that of the planar base.

5. The adjustable mount of claim 4, wherein the planar base includes a pair of through-slots for receiving mounting screws therethrough.

6. The adjustable mount of claim 5, wherein:
the pair of through-slots are straight and extend into opposing end faces of the planar base; and
the pair of through-slots extend along the same line or respectively extend along parallel lines.

7. The adjustable mount of claim 1 wherein the through-hole is elongated towards or away from the arcuate through-slot.

8. The adjustable mount of claim 7 wherein the platform sits on from a vertical beam extending from the base.

9. The adjustable mount of claim 1 electrical or optical device is a snap-action switch.

10. An adjustable mount for an electrical or optical device comprising:
a base configured to be coupled or attached to an object; and
a platform coupled to and elevated above the base, the platform including,
a top mounting surface,
a through-hole approximate a first end of the top mounting surface for receiving a first screw extending from a component to be mounted thereon, and
an arcuate through-slot approximate a second end of the top surface opposite the first end for receiving a second screw extending from the component to be mounted thereon, the arcuate through-slot having a radius of curvature centered near or on the through-hole.

11. The adjustable mount of claim 10, further comprising a right-angle adaptor mounted to the top mounting surface.

12. The adjustable mount of claim 10 fabricated from an electrically insulative material.

13. The adjustable mount of claim 10, wherein:
the platform includes a bottom surface; and
the bottom surface includes an arcuate track following the path of the arcuate through-slot, the acuate track dimensioned to capture a hex-nut therein and allow the hex-nut to slide along the arc of the track without rotation.

14. The adjustable mount of claim 13, wherein the bottom surface further includes at least a partially hexagonal wall surrounding the through-hole for seating a hex-nut therein without rotation.
